(19) United States
(12) Patent Application Publication
(10) Pub. No.: US 2008/0279341 A1
(43) Pub. Date: Nov. 13, 2008

(54) Kelley Caps a see-thru X-ray cassette cap (cover) to use over an x-ray cassette/electronic plate cassette with the top of cap covered with 1/2 inch high impact polystyrene

(76) Inventor: Wanda Gail Haywood Kelley, Columbia, TN (US)

Correspondence Address: Gail H. Kelley, 1153 Bear Creek Pike, Columbia, TN, 38401, US

(21) Appl. No.: 11/746,842

(22) Filed: May 10, 2007

(51) Int. Cl. H05G 1/00

(52) U.S. Cl. 378/204

(57) ABSTRACT

The purpose of the Kelley Cap is to be used in x-ray procedures to cover x-ray cassette and protect x-ray cassette during exam. Example: Kelley Cap over x-ray cassette during a standing AP foot exam or x-ray to prevent pressure/weight on cassette (also keeping cassette clean and pressure free).

Basically, the Kelley Cap is a frame (wood, aluminum or metal) approx. 2 inches in height (or more) and the size depends on the size of the cassette that it will be covering. The Kelley Cap fits over an x-ray cassette to protect it from pressure, weight and to keep the cassette clean.

The Kelley Cap can be used for other (extremity) X-Ray exams.

### BRIEF DESCRIPTION OF REPLACEMENT DRAWING

FIG. 1 A—Top view of Kelley Cap

FIG. 1 B—Lexan or plexiglass to slide into groove opening of Kelley Cap

FIG. 1 C—End cap fits into end of Kelley Cap after Lexan or plexiglass is in place

FIG. 2 A—Side view of Kelley Cap

FIG. 2 B—½″ X-ray cassette fits inside open area under Kelley Cap

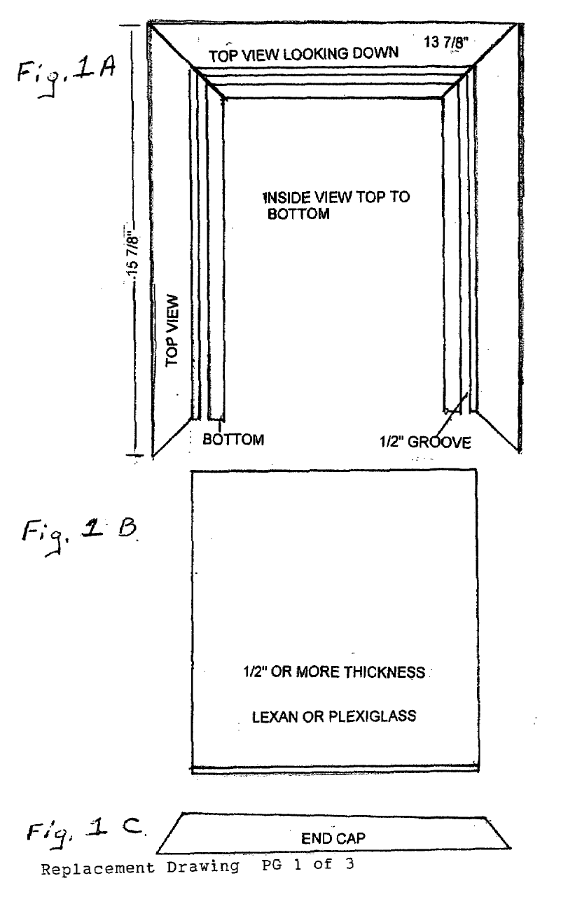

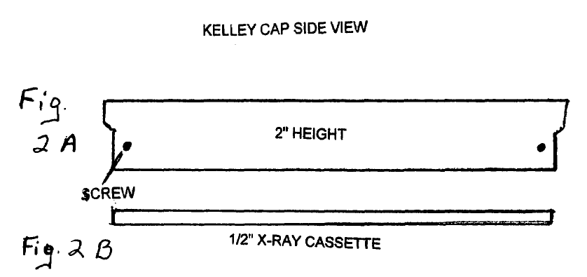

What is claimed is:

1. The Kelley Cap is a frame (wood, aluminum or metal) with ½ inch (or more) thick high impact polystyrene that fits over the x-ray cassette to provide a see-thru method of doing the x-ray without any pressure being placed on the equipment/cassette.
